(19) United States
(12) Patent Application Publication
(10) Pub. No.: US 2016/0337433 A1
(43) Pub. Date: Nov. 17, 2016

(54) SYSTEMS AND METHODS FOR DATA SYNCHRONIZATION RELATED TO TRANSMISSION OF VIDEO OVER A NETWORK

(71) Applicant: Gamesys Ltd., London (GB)

(72) Inventors: Hans Elias, Hertfordshire (GB); Jason Kempster, London (GB); Mouttapha Mouhamadou Camara, Essex (GB)

(21) Appl. No.: 15/151,231

(22) Filed: May 10, 2016

Related U.S. Application Data
(60) Provisional application No. 62/160,093, filed on May 12, 2015.

(30) Foreign Application Priority Data
May 12, 2015 (GB) 1508105.2

(51) Int. Cl. H04L 29/06; H04N 19/17; H04N 19/182

(52) U.S. Cl. CPC H04L 65/601; H04N 19/182; H04N 19/17; H04L 65/607

(57) ABSTRACT

A computer system according to some embodiments is operable to facilitate synchronization between two or more data streams transmitted over an electronic network from a first computing system to a second computing system by inserting a visual code (e.g., a bar code) comprising encoded second data into a video data stream in order to allow the receiving computing system to synchronize scenes depicted by the video data with information represented in the visual code when displaying the scenes to a user.

The present application claims priority under 35 U.S.C. §119(e) to, and is a non-provisional of, U.S. Provisional Patent Application No. 62/160,093 filed on May 12, 2015 in the name of Elias et al. and titled DATA SYNCHRONISATION, the contents of which are hereby incorporated by reference herein.

The present application also claims priority to UK Application No. 1508105.2, filed with the United Kingdom Patent Office on May 12, 2015, published as GS 2527662 on Dec. 12, 2015 and granted as U.S. Pat. No. 2,527,662 as of May 25, 2016, which is titled DATA SYNCHRONISATION. The entirety of this application is incorporated by reference herein.

### COPYRIGHT NOTICE

A portion of the disclosure of this application contains material that is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### BACKGROUND

The present disclosure relates to the synchronizing data and video streams, and in particular to the synchronization of such streams for the distribution of visual data over a computer network. In the environment of computer networks and transmitting a live video stream over a computer network to a receiving computing device, Applicant has recognized that due to inherent difficulties and drawbacks of traditional protocols for transmitting video streams over a computer network (e.g., lag time created by packet switched protocols or weaknesses of an internet or other network connection at the receiving computer system), by the time the video stream is received at a receiving computing device it may no longer depict a most current status of an event depicted in the video stream. For example, in the case of a live game that is being transmitted via a video stream to remote players, and particularly in the case of a live game in which events move quickly or the status of the game may change quite suddenly, even a relatively small delay in the transmission of the video stream (e.g., a second or less delay) may cause the viewer of the video stream at the receiving computing device to not be viewing the most up to date information regarding the game as it stands in the live environment. Additionally, in scenarios where it is desirable to output additional data to a viewer of the video stream with respect to the game (e.g., to activate a wager function or deactivate such when betting is no longer being accepted at the live wagering game, or to depict the result of a video roulette game once the ball stops in a particular spot on the roulette wheel) or to otherwise synchronize two or more data streams being transmitted to a receiving computing device, it may be particularly important that the two or more data streams (e.g., a video stream and the additional data being depicted) be synchronized precisely and account for any lag or delays in one or more of the data streams during the transmission process. Applicant has recognized that assuring such synchronization among two or more data streams being transmitted for a particular event may prove challenging, particularly when the additional data is being generated based on the video stream as a distinct functionality.

Packet switched protocols are the basis of communication across the internet and provide a well-developed system for data communications. It is common to use such protocols for the transmission of all types of data. Although packet switched protocols provide an efficient mechanism for routing data between interconnected computers, such protocols also have drawbacks.

A packet switched protocol operates by separating data into a series of packets and routing each one independently over the network. In a simple point-to-point data connection there is only one route packets can take, but in complex networks packets may be routed in any number of unpredictable (and uncontrollable) routes. Each packet may take a different amount of time to get to its destination, and there is no guarantee as to the order in which packets will be received.

The route taken, and hence delay from transmission to reception, by individual packets depends on a range of factors, including the configuration of routers and the capacity of available routes. Such factors are unpredictable and may vary over time, thus giving a variable transmission delay.

Such variable transmission delays do not typically affect system performance when a single data stream is being transmitted because packets are re-assembled into the correct order at the destination, and the absolute delays are typically small in terms of a user's perception. However, where there is a need to maintain synchronization between more than one independent data stream the variable delay becomes more problematic. For example, a first data stream may comprise video data for display in real-time at a destination computer, and a second data stream may comprise data relating to the video and which is time-dependent in relation to that video. For example, in an internet-based gambling system the video may be of a roulette wheel or other live wagering game, and the data relating to that video may be the result of a spin, other game event or betting information. For a good user experience, as well as efficiency and credibility in facilitating transactions (e.g., wagers and results of wagers) that depend upon the video and related data being in synch, it is important the data is displayed to the user in synchronization with the video.

There is therefore a need for a system to facilitate synchronization of separate, but related, data streams that may become out of synch during a transmission process.

### BRIEF DESCRIPTION OF THE FIGURES

An understanding of embodiments described herein and many of the attendant advantages thereof may be readily obtained by reference to the following detailed description when considered with the accompanying drawings, wherein:

FIG. 1 comprises a schematic diagram of an example system for the transmission of related data streams, in accordance with some embodiments;

FIG. 2 comprises a flow chart of an example method of creating and transmitting a video stream with encoded data, in accordance with some embodiments;

FIG. 3 illustrates example embodiments of encoded data;

FIG. 4 comprises a schematic diagram of an example system for receiving an encoded video stream, in accordance with some embodiments;

FIG. 5 comprises a flow chart of an example method of receiving, decoding, and displaying encoded video data, in accordance with some embodiments; and

FIG. 6 comprises a schematic diagram of an exemplary computing device that may be useful in at least some embodiments.

### DETAILED DESCRIPTION

In accordance with some embodiments, systems, methods and articles of manufacture provide for facilitating the transmission of video and related data from a first computer system to a second computer system by acquiring video data at the first computer system representing a scene; generating data at the first computer system, the data at least partly relating to the scene represented by the video data, encoding the data in to a visual form to form a visual code; merging the visual code with at least one frame of the video data, such that the visual code appears within the representation of the scene (e.g., forming a composite image by merging the visual code with at least one frame of the video data); and transmitting the merged data to a second computer system. In some embodiments, the systems, methods and articles of manufacture may further provide for transmitting unsynchronized, but related, data from the first computer system to the second computer system.

In accordance with some embodiments, systems, methods and articles of manufacture may further provide for receiving the merged data (e.g., the composite image) at the second computer system; receiving the unsynchronized data at the second computer system; extracting the visual code from the merged data at the second computer system; decoding the visual code to obtain the data; decoding the merged data and displaying the scene represented by the video data in the merged data on a display device of the second computer system; and displaying information on the display device derived from the data and the unsynchronized data.

In accordance with one embodiment, the data may be encoded in to a visual form by representing the data as a binary number and representing each digit of the binary number as an area of pixels. For example, a first or a second colour may be used for the pixels of the area corresponding to each digit is selected dependent on the value of the digit. In one embodiment, the area may be an area of 8×8 pixels and a first colour is white and a second color is black.

In accordance with one embodiment, merging may comprise overwriting an area of the video frame with the visual code. In another embodiment, merging may comprise modifying parameters of pixels of the video frame based on the visual code.

In accordance with one embodiment, the video data may be processed, upon being received at the second computer system, such that the displayed scene does not include the visual code (e.g., such that it is not visible to a viewer of the video, such a as a remote player of a live game being displayed via the video). For example, the visual code may be removed from the displayed scene and/or the composite image may be modified to remove the visual code. In other embodiments, the visual code may be within the scene to be displayed when the video is played (e.g., such that it is visible to a viewer of the video).

In accordance with some embodiments, systems, methods and articles of manufacture provide for receiving video and related data at a second computer system from a first computer system, by receiving merged data at the second computer system, wherein the merged data comprises video data, wherein the video data comprises at least one frame including a visual code; extracting the visual code from the merged data at the second computer system; decoding the visual code to obtain data encoded as the visual code; decoding the video data and displaying scenes represented by the video data on a display device of the second computer system; and displaying information on the display device derived from the data and the unsynchronized data.

In accordance with one embodiment, the visual code may comprise a plurality of pixel areas, each area representing a digit of a binary number. In accordance with some embodiments, the value of each digit may be represented by the colour of the respective area of pixels. In accordance with some embodiments, each area may be an area of 8×8 pixels and a first color may be white and a second color may be black.

In accordance with some embodiments, the systems, methods and articles of manufacture may further provide for processing the video data at the second computer system such that the displayed scene does not include the visual code (e.g., such that it is not visible to a viewer of the video, such a as a remote player of a live game being displayed via the video). For example, the visual code may be removed from the displayed scene and/or the composite image may be modified to remove the visual code. In other embodiments, the visual code may be within the scene to be displayed when the video is played (e.g., such that it is visible to a viewer of the video).

Certain aspects, advantages, and novel features of various embodiments of a roulette game are described herein. It is to be understood that not necessarily all such advantages may be achieved in accordance with any particular embodiment. Thus, for example, those skilled in the art will recognize different embodiments may be implemented or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. Other terms are defined throughout the present description.

A “game”, as the term is used herein unless specified otherwise, may comprise any game (e.g., wagering or non-wagering, electronically playable over a network) playable by one or more players in accordance with specified rules. A game may be playable on a personal computer online in web browsers, on a game console and/or on a mobile device such as a smart-phone or tablet computer. A game may also be playable on a dedicated gaming device (e.g., a slot machine in a brick-and-mortar casino). “Gaming” thus refers to play of a game.

A “wagering game”, as the term is used herein, may comprise a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” refers to play of a wagering game.

The term “game provider”, as used herein unless specified otherwise, refers to an entity or system of components which provides, or facilitates the provision of, games for play and/or facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate or facilitate a gambling website over which wagers are accepted and results of wagering games are provided.

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game).

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

An “game event”, “event instance”, “game instance”, “spin” or “turn” is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance). An event instance or turn may comprise an event instance or turn of a primary game or an event instance or turn of a bonus round, mode or feature of the game.

“Virtual currency” as the term is used herein unless indicated otherwise, refers to an in-game currency that may be used as part of a game or one or more games provided by a game provider as (i) currency for making wagers, and/or (ii) to purchase or access various in-game items, features or powers. References to an “award”, “prize” and/or “payout” herein are intended to encompass such in the form of virtual currency, credits, real currency or any other form of value, tangible or intangible.

A “credit balance”, as the term is used herein unless indicated otherwise, refers to (i) a balance of currency, whether virtual currency or real currency, usable for making wagers or purchases in the game (or relevant to the game), and/or (ii) another tracking mechanism for tracking a player's success or advancement in a game by deducting therefrom points or value for unsuccessful attempts at advancement and adding thereto points or value for successful attempts at advancement. A credit balance may be increased or replenished with funds external to the game. For example, a player may transfer funds to the credit balance from a financial account or a gaming establishment may add funds to the credit balance due to a promotion, award or gift to the player.

The various features and embodiments described herein may be combined as appropriate, as would be apparent to a skilled person up on reading the present disclosure, and need not be combined strictly in the manner described herein. Throughout the drawings, like reference symbols refer to like features or steps.

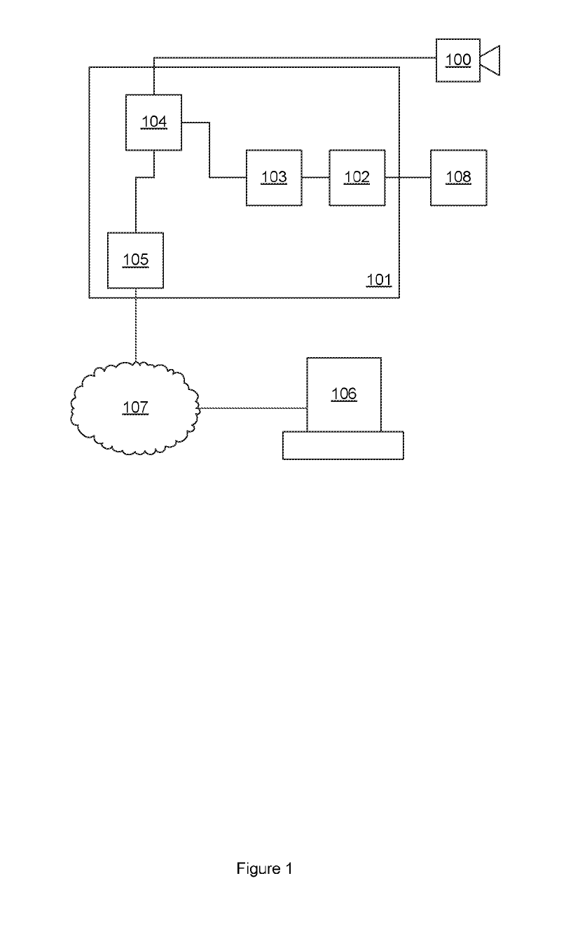

Turning now to FIG. 1, illustrated therein is a schematic diagram of an example system for providing a live video stream and associated data to a user (e.g., a player of a game, such as a player who is remotely participating in a live roulette game via a video feed of the game). A video camera 100 captures a video of a scene for transmission to a user. For example, the video may capture a roulette wheel during play. The video camera 100 may be operatively coupled or in communication with a computer system 101 for processing and transmission of the video. The computer system 101 may comprise one or more servers or other computers that are operable to process the video in accordance with embodiments described herein.

In accordance with some embodiments, computer system 101 may include (or be operable to communicate and exchange data with) a data generation system 102 for generating data for transmission to a user, which data is related to the video. While data generation system 102 is illustrated in FIG. 1 as being a component of computer system 101, in other embodiments it may be a component of a different computer system with which computer system 101 is operable to communicate. In accordance with some embodiments, data generation system 102 may be operable to communicate with (e.g., receive data from) roulette wheel 108 to receive information from sensors gather data related to the wheel. In embodiments in which the game is other than a roulette wheel, the roulette wheel 108 may be replaced with a different component of the game that is equipped with sensors operable to provide relevant data to data generation system 102.

In accordance with some embodiments, computer system 101 may include (or be operable to communicate and exchange data with) an encoding system 103. While encoding system 103 is illustrated in FIG. 1 as being a component of computer system 101, in other embodiments it may be a component of a different computer system with which computer system 101 is operable to communicate. In accordance with some embodiments, encoding system 103 encodes data from data generation system 102 in a graphical form and communicates that data to video merge system 104. In accordance with some embodiments, video merge system 104 merges data from the video camera 100 and encoding system 103 into a video stream for transmission to remote computer systems (e.g., player devices, PCs or other electronic devices of users). While video merge system 104 is illustrated in FIG. 1 as being a component of computer system 101, in other embodiments it may be a component of a different computer system with which computer system 101 is operable to communicate.

In accordance with some embodiments, computer system 101 may include (or be operable to communicate and exchange data with) a transmission system 105. While transmission system 105 is illustrated in FIG. 1 as being a component of computer system 101, in other embodiments it may be a component of a different computer system with which computer system 101 is operable to communicate. In accordance with some embodiments, transmission system 105 may be operable to accept data from merge system 104 and transmits the data to a user's computer system 106 (also referred to as a player device 106 herein) via a network 107. Network 107 may comprise, for example, the Internet.

In some embodiments, one or more components of computer system 101, one or more components of computer system 106 and/or one or more components of another computer system described herein may further comprise a processor (e.g., one or more microprocessors, one or more microcontrollers, one or more digital signal processors). The processor may receive instructions (e.g., from a memory or like device), and execute those instructions, thereby performing one or more processes defined by those instructions. Instructions may be embodied in, e.g., one or more computer programs and/or one or more scripts. In some embodiments a processor (e.g., one or more microprocessors, one or more microcontrollers, one or more digital signal processors, or one or more processing units) of computer system 101 may receive instructions (e.g., from a memory or like device), and execute those instructions, thereby performing one or more processes defined by those instructions. Instructions may be embodied in, e.g., one or more computer programs and/or one or more scripts.

As described herein, in accordance with some embodiments a software application or program may be downloaded and/or installed onto a computing device (e.g., a player device or server device), for facilitating one or more functions, programs or processes described herein. Such a software application or program may further comprise one or more software module(s) for directing a processor of the player device to perform certain functions. In accordance with some embodiments, software components, applications, routines or sub-routines, or sets of instructions for causing one or more processors to perform certain functions may be referred to as “modules”. It should be noted that such modules, or any software or computer program referred to herein, may be written in any computer language and may be a portion of a monolithic code base, or may be developed in more discrete code portions, such as is typical in object-oriented computer languages. In addition, the modules, or any software or computer program referred to herein, may in some embodiments be distributed across a plurality of computer platforms, servers, terminals, and the like. For example, a given module may be implemented such that the described functions are performed by separate processors and/or computing hardware platforms.

It should be understood that any of the software module(s) or computer programs described herein may be part of a single program or integrated into various programs for controlling a processor of a computing device. Further, any of the software module(s) or computer programs described herein may be stored in a compressed, uncompiled, and/or encrypted format and include instructions which, when performed by a processor, cause the processor to operate in accordance with at least some of the methods described herein. Of course, additional and/or different software module(s) or computer programs may be included and it should be understood that the example software module(s) described herein are not necessary in any embodiments. Use of the term “module” is not intended to imply that the functionality described with reference thereto is embodied as a stand-alone or independently functioning program or application. While in some embodiments functionality described with respect to a particular module may be independently functioning, in other embodiments such functionality is described with reference to a particular module for ease or convenience of description only and such functionality may in fact be a part of integrated into another module, program, application, or set of instructions for directing a processor of a computing device.

According to some embodiments, the instructions of any or all of the software module(s) or programs described herein may be read into a main memory from another computer-readable medium, such from a ROM to RAM. Execution of sequences of the instructions in the software module(s) or programs may cause a processor to perform at least some of the process steps described herein. In alternate embodiments, hard-wired circuitry may be used in place of, or in combination with, software instructions for implementation of the processes of the embodiments described herein. Thus, the embodiments described herein are not limited to any specific combination of hardware and software.

Referring again to FIG. 1 in particular, in accordance with some embodiments at least one of data generation system 102, encoding system 103, video merge system 104 and/or transmission system 105 may comprise hardware, such as at least one processor and/or memory that is distinct from a processor or memory of the computer system 101. In other embodiments, at least one of generation system 102, encoding system 103, video merge system 104 and/or transmission system 105 may comprise software (e.g., a subroutine or module of a larger program) and may run based on instructions of a processor that is operable to facilitate various subroutines or modules (e.g., a processor of computer system 101).

As explained below, computer system 106 is provided with systems to decode the merged video data and display the video and data to the user. Since a single stream of data is transmitted, the data from system 102 remains synchronized with the data from video camera 100, and the output to a user at computer system 106 can present synchronized live and generated data, thereby addressing the drawbacks of prior systems. Transmission system 105 may transmit the same data to one or multiple destination systems and any appropriate form of transmission may be utilized.

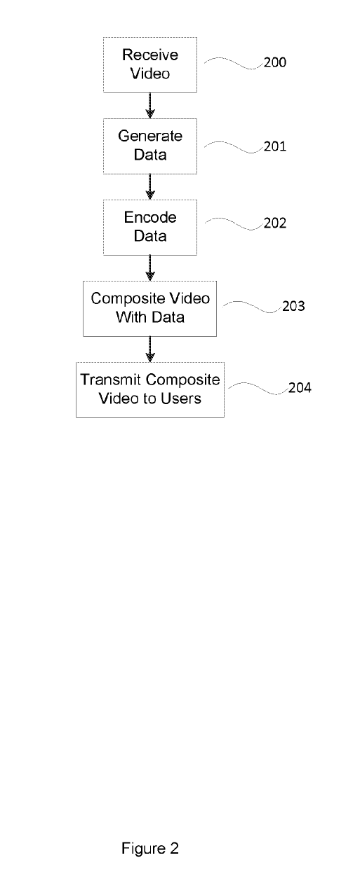

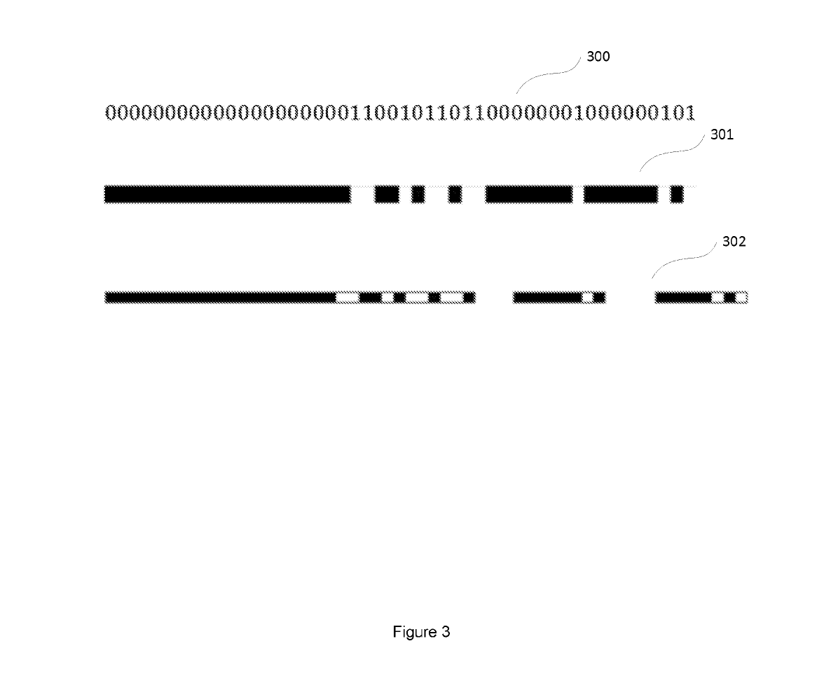

Referring now to FIG. 2, illustrated therein is a flow-chart of an example process of encoding data to maintain synchronization between related data streams that may be transmitted separately or as distinct packets. The process of FIG. 2 may be performed, for example, by at least one component of computer system 101. It should be noted that additional and/or different steps may be added to those depicted and that not all steps depicted are necessary to any embodiment described herein. The process of FIG. 2 is an example process of how some embodiments described herein may be implemented, and should not be taken in a limiting fashion. A person of ordinary skill in the art, upon contemplation of the embodiments described herein, may make various modifications to the process of FIG. 2 without departing from the spirit and scope of the embodiments in the possession of applicant. Reference is made to FIG. 3, which illustrates an example of how data may be represented, in the description of process of FIG. 2.

At step 200 a stream of video data is received at a computer system 101 from video camera 100. At step 201 generation system 102 generates data related to the video data stream. In general the generated data could be any data (whether relevant to the video data or not), but will typically be information relevant to the status of the events being shown in the video stream, or other related information. In a specific example, the video stream may show a roulette wheel, in particular while a ball is in play in the wheel. The generation system 102 may generate data indicating that the ball is in play, betting odds available for placing a bet at that particular moment, an indication that betting is open or closed, or the result of the game. The generation system may receive signals from sensors on the wheel to contribute to the generation of the data. For example, sensors may report the position, wheel speed, wheel direction. The wheel may also signal information such as game state, for example place bets, no more bets, and the winning number. Furthermore, the data may be partially or entirely manually generated data. Different combinations of signals may be provided without departing from the principles described herein. Information may be generated by the wheel automatically from the sensors detecting the information, or the sensors may comprise a user interface to allow a user to input the information (for example a user may press a “no more bets” button at an appropriate point in the spin).

In accordance with some embodiments, the generation system 102 generates data in real-time in synchronization with the video-stream such that there is alignment in time between the frames in the video stream and the data. For example, in some embodiments it may be important that certain events such as a change in a stage or status of the game (such as a the change from betting open to betting closed) may be indicated in the data at the correct moment of the video. In one embodiment, data is generated for each frame of the video stream (e.g., at a rate of 24 frames/second). The data may be updated for each frame, or the same data may be transmitted in a sequence of frames. Furthermore, it may not be necessary to include data in every frame. For example, a new set of data may be included in one or more frames, but then no data is sent until the data changes. Such a technique may decrease the impact of the data on the appearance of the video to users, in embodiments where this is a concern.

At step 202 the data generated by the generation system 102 is encoded by encoding system 103. Encoding system 103 encodes the data in visual form for later merging within the visible area of the video. The encoded data will be referred to as a visual code for convenience. Various different encoding schemes can be utilized and the method is independent of the actual code or scheme used, provided the result can be merged with images in a video stream for later extraction. Examples are set out below of exemplary coding schemes, but other comparable schemes may also be utilized.

In a first example the data is a set of integers, each integer representing a part of the generated data. For example, the set of integers may include:
A game reference indicating the type of game or game serial number.
A number indicating events, for example, game finished, ball in play, or wheel stopped.
The number the ball lands in to indicate the result.

The above parameters are provided as examples only. In some embodiments, only a subset, or additional, parameters may be included.

In accordance with one embodiment, the meaning of the parameters may be transmitted to user's computers as a separate data transmission as part of the application being used by the user, or the encoded data may contain sufficient information for the user's computer to use the data directly. The format of the encoding may be included in such an application, or may also be transmitted to the user's computer via a separate data connection.

In accordance with one embodiment, each integer is converted to a binary representation and the resulting binary strings concatenated. For example:
Game reference=3254—encoded as 32 bits 00000000000000000000110010110110
Game finished event=2—encoded as 8 bits=00000010
Result=5—encoded as 8 bits=00000101

Concatenating these together gives 48 bits of information as shown at 300 in FIG. 3. In accordance with some embodiments, error correction coding may be applied to the data to enable the detection and correction of errors at the receiver. For example, additional Cyclic Redundancy Check (CRC) check bits may be calculated and added to the data.

In accordance with some embodiments, each bit may be converted to an image area such that the string of bits is represented by a contiguous group of pixels forming an encoded image. For example, each bit may be represented by an 8×8 pixel square, with a black square indicating a 0, and a white square indicating a 1, as shown at 301 of FIG. 3. The representations of the individual integers within the visual code are shown at 302 of FIG. 3.

In variations on this encoding scheme different sized pixel areas and different colors may be utilized. Furthermore, a multi-level coding scheme may be utilised such that each area can carry more than one bit of information. For example, four colors may be utilized to represent two bits of information. The area and colors of the encoded image may be selected to provide the preferred balance between disruption of the video images (due to a large and bold encoded image) and difficulty of decoding (due to a small encoded image or use of colours which blend with the actual video images).

At step 203 the encoded image (e.g., such as image 301 of FIG. 3) is merged with the video stream data by an appropriate subroutine, program or computer component (e.g., by the video merge system 104 of FIG. 1). The merging process may be conducted using a number of methods for compiling a composite image from two sources. For example, pixels of the video stream (more specifically, of each frame of the video stream) may be overwritten by the encoded image. The composite image may thus comprise a small region which appears as per the encoded image. The encoded image may be placed in any location in the area of the video images. In one embodiment it may be positioned in an area of lower of interest to the user, for example in a corner of the display, to avoid degrading the visual experience. In accordance with some embodiments, the encoded image may be placed in a region of the frame which can be cropped when the video is played back. In some embodiments, a distinct encoded image (e.g., an image such as image 301 of FIG. 3) may be placed in each frame of the video stream, the encoded image representing a status of the circumstances (e.g., a status of the game) depicted in the corresponding frame of the video stream.

In another embodiment, a merging process may comprise modifying the pixel colors of the video frames based on the encoded image, but not overwritten completely. For example, a particular color entry (Red, Green, Blue) in the color code for the pixel may be increased or decreased by a certain amount depending on the color in the encoded image, or the brightness may be increased or decreased. Such techniques may reduce the prominence of the encoded image to the viewer but still be decoded by a receiving computer system or device (e.g., by a player device or a server operable to decide the image and output it to a player device, such as via a web browser).

The merging process may be performed in any appropriate manner. Typical examples may include displaying the visual code on a computer screen and transmitting all or regions of that screen to a compositing system to merge the data. If the video stream is, or includes, animations then the visual code can be included in that animation as the animation is generated.

The composite video stream thus carries data overlaid on the scene represented by the video.

At step 204 a program, module, subroutine or component of a computer system (e.g., the transmission system 104 of FIG. 1) transmits the composite video stream to users 106 via a network 107. For example, the video may be transmitted using a streaming protocol over the internet. The video transmission operates in the conventional way since the composite video is a conventional video, with only the image data being modified but with no changes to structure or coding.

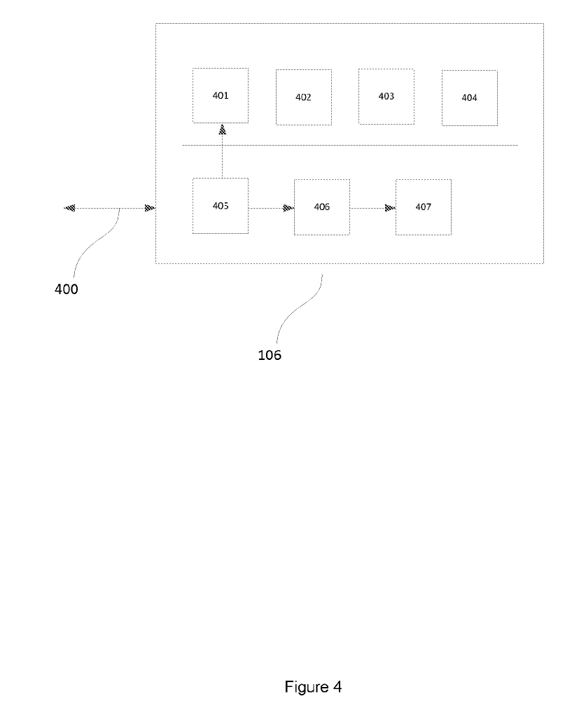

Referring now to FIG. 4, illustrated therein is a schematic block diagram of a user's computer system 106 (e.g., a player device) for use in receiving and decoding composite images generated and transmitted using the techniques described with reference to FIGS. 2 and 3 and elsewhere herein. In some embodiments a player device may access a server device as a client via a browser on the player device and the player may remotely participate in a live game consistent with at least some embodiments described herein by accessing a game interface using a browser rather than (or in addition to) having game logic or image decoding logic downloaded to or stored locally on the player device. In such embodiments, the decoding of an image or other functions described herein may take place at a server device (e.g., a server device that is distinct from a computing device that encodes data and generates a composite image using video of the live game and the data, such as computer system 101 of FIG. 1). Such a server device may, in some embodiments, output a video synched with game data in accordance with embodiments described herein via a web browser of the player device. Thus, in some embodiments, computer system 106 may comprise a server device of a game server rather than a player device. Even in embodiments in which computer system 106 comprises a player device, some of the components or functionality described with respect to FIG. 4 may be performed by a server device of a game provider rather than the player device (or in cooperation with the player device).

In accordance with some embodiments, the computer system 106 of FIG. 4 may be a one or more server computers, a conventional personal computer (PC), tablet, a dedicated gaming system, mobile device, player device or any device capable of use by a user to execute applications. The computer system 106 may comprise a network connection 400 for transmitting and receiving information from remote computers (e.g., for communicating with computer system 101 of FIG. 1). That network connection may be a wired or wireless connection and may provide data connectivity via any known means.

In some embodiments, the computer system 106 may further comprise a display 401, which may be operable to output images to a user in accordance with embodiments described herein. In accordance with some embodiments, the computer system 106 may further comprise at least one input device 402 such as a keyboard, mouse, and/or touchscreen, for facilitating user interaction with the computer system 106. Computer system 106 may further comprise a memory 403, operable to store programs and data for execution and processing (e.g., by processing system 404, which may also be a component of computer system 106).

As will be appreciated various other systems and connections are present in computer systems and FIG. 4 is only intended as an overview of the features which may be relevant to the present disclosure. Connections shown in FIG. 4 are for convenience only and the lack of a line between components in FIG. 4 does not indicate that those components are not connected. Rather, each component communicates as appropriate to conduct the desired processes and functions.

In accordance with some embodiments, computer system 106 may comprise a video processing system 405 (e.g., in the form of a program, application, subroutine or module comprising software to be executed on the computer system 106). In accordance with some embodiments, video processing system 405 may be configured to receive video data from the network connection 400, memory 403, or other source, and to decode and display the video on display 401 or a display of a player device that is in communication with computer system 106 via a web browser (in embodiments in which the computer system 106 is distinct from a player device). Video processing system 405 may also, in some embodiments, be configured to output sections (or the whole) of each frame of the video to image processing system 406.

In accordance with some embodiments, image processing system 406 may be configured to analyze received images and to decode data encoded in that image. In accordance with some embodiments, the image processing system 406 may output decoded data to application 407, which may utilize the decoded data as described herein. In accordance with some embodiments, application 407 may be a standalone application running on the computer system 106. In another embodiment, application 407 may comprise an application running with a web-browser. The application may control only use of the data, or may also control display of the video.

According to some embodiments, the computer system 106 of FIG. 4 may further comprise one or more processors (not shown) for directing one or more components, programs, subroutine, modules or applications thereof. In one embodiment, distinct processors may be associated with distinct components of the computer system while in other embodiments a single processor or set of processors may direct all components of the computer system. Such one or more processors may be or include any type, quantity, and/or configuration of processor that is or becomes known (e.g., an Intel® IXP 2800 network processor or an Intel® XEON™ Processor coupled with an Intel® E7501 chipset). In some embodiments, such one or more processors may comprise multiple inter-connected processors, microprocessors, and/or micro-engines. According to some embodiments, such one or more processors (and/or the computer system 106 and/or other components thereof) may be supplied power via a power supply (not shown) such as a battery, an Alternating Current (AC) source, a Direct Current (DC) source, an AC/DC adapter, solar cells, and/or an inertial generator. In the case that the computer system 106 comprises a server such as a blade server, necessary power may be supplied via a standard AC outlet, power strip, surge protector, and/or Uninterruptible Power Supply (UPS) device.

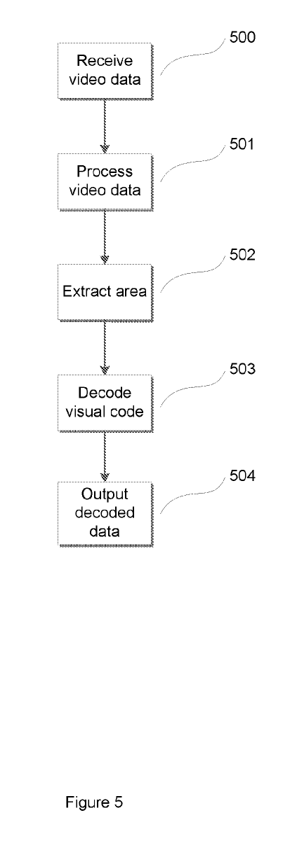

Turning now to FIG. 5, illustrated therein is a flowchart of a method of receiving and processing data in accordance with one embodiment. The method of FIG. 5 may be performed, for example, by computer 106 or a component thereof. At step 500 a stream of video data encoded according to the method described in relation to FIG. 2 is received (e.g. by computer system 106 via connection 400). For example, in accordance with some embodiments, one or more frames of the video may include visual codes.

At step 501 the video data is received and processed for output on a display. In accordance with some embodiments, the video data may be received by video processing system 405 of computer system 106 as embodied in FIG. 4. In accordance with some embodiments the display may comprise display 401 of the computer system 106 as embodied in FIG. 4.

At step 502 a predefined area of the at least one frame that includes at least one visual code may be extracted from at least one frame. In accordance with one embodiments, step 502 may further include passing or transmitting the data representing that area to another component or system (e.g., to image processing system 405 of computer system 106 as embodied in FIG. 4). In accordance with some embodiments, step 502 may further comprise cropping or otherwise modifying the video frames to remove the area of the image comprising the visual code. The extraction of an area of a video frame may be performed by the video decoding system itself, or add-ins or other software may be utilized to perform this function. The area to be extracted may be predefined in the software, or may be transmitted to a system or computing device (e.g., to the computer system 106) via a data connection such that the area can be varied. In accordance with one embodiment, at least some functions described herein with respect to step 502 may be performed by a component of computer system 106 as embodied in FIG. 4 (e.g., by video processing system 405).

In accordance with some embodiments, at least one image correction process may be applied to an encoded region of an image such that the code is not visible, or has reduced visibility, in the displayed image. For example the area of a frame that had been occupied by encoded data or an encoded image may be “filled in” or recreated from surrounding image data once the encoded data is extracted, to provide a visually continuous image in the frame such that the area of the frame in which the encoded data had been placed is not visually defined to a viewer of the frame once the encoded data is extracted.

At step 503 received images are analyzed to identify the region containing encoded data. For example, in some embodiments the area output by the video processing system 405 or other component operable to output the area may be larger than the encoded area. In accordance with some embodiments, step 503 further comprises decoding the encoded data to extract the data. In the example encoding scheme described above a binary number was encoded as a sequence of black or white squares. If that encoding scheme is utilized, decoding the data may comprise identifying the series of squares and converting each square into a binary digit. Other processing methods may be applied depending on the encoding scheme utilized. In accordance with some embodiments, at least some functions described with respect to step 504 may be performed by a component of computer system 106 as embodied in FIG. 4 (e.g., by image processing system 406).

At step 504 the decoded data is passed to application 407 which may be a software program running on computer system 106. Application 407 extracts the individual sections of data from the decoded data to recover the original data. In the above example the binary string is separated into three parts, each part representing an integer. As appropriate for the particular protocol error correction techniques are applied to check for errors in the received data and to correct them.

In accordance with some embodiments, the data output at step 504 is synchronized with the video stream as a result of the data having been received encoded within the video stream, thereby addressing at least some drawbacks of prior systems. Although the example described above describes outputting the video to a display prior to decoding the data, these steps or operations may also be performed in different orders. For example, the video output may be delayed until processing is complete to avoid any lag between video being displayed and the data being available. Furthermore, the division of function between systems may be varied, or all performed in one application.

In accordance with some embodiments, a component of a computing system operable to performed at least some steps of the process described with respect to FIG. 5 (e.g., application 407 of computer system 106 as embodied in FIG. 4) may utilize the data to provide or modify functions and/or information made available to users. For example, information may be displayed on a display (e.g., display 401 of FIG. 4) alongside or over the video feed. For example, a user interface of the game may be updated (e.g., a graphic, animation, text and/or functionality), added, removed, activated and/or deactivated based on the data. In one embodiment, the data represents an indication of an event which occurred during a game represented in the video stream and the data may indicate that the event is depicted in the particular frame of the video stream in which the data was included as encoded data. A state of the user interface of the game may thus be synched with the video stream (which video stream may be output within an area of the user interface) such that the user interface appropriately indicates the event as it is depicted in the video stream. For example the winning number of a roulette game may be displayed, or whether betting is open or closed may be selected for display and/or displayed based on the decoded data.

In accordance with some embodiments, a component of a computing system operable to performed at least some steps of the process described with respect to FIG. 5 (e.g., application 407 of computer system 106 as embodied in FIG. 4) may also utilize the decoded data to control functions and services provided to a user (e.g., a player of a player device). For example, while the data indicates that betting is open the application 407 may accept bets through a user interface displayed on display 401, but this function may be disabled once the data indicates that betting is closed.

In accordance with some embodiments, a component of a computing system operable to performed at least some steps of the process described with respect to FIG. 5 (e.g., application 407 of computer system 106 as embodied in FIG. 4) may be in communication with a second computer system (e.g., computer system 101) to exchange additional (unsynchronised) information such as bets, financial information, gaming and graphic information, or any other information to allow the provision of the application's functions to users.

In one embodiment, utilizing the data from a current at least one frame of a video stream may comprise determining the particular event represented by the data, comparing the event to an event indicated via encoded data included in at least one preceding frame of the video stream and updating a user interface of a player device if the event indicated in the current frame of the video stream is different from the event indicated in the preceding frame of the video stream.

As noted above, the application 407 may, in some embodiments, be a standalone application loaded on to a computer system (e.g., computer system 106) while in other embodiments it may comprise a web-based application with only minimal software at a player device or other user computer system.

It should further be noted that, where reference has been made with respect to the process of FIG. 5 (or with respect to the process of FIG. 2) to certain functions or processes being performed by particular systems this is for ease of description only and is not intended to restrict this disclosure to any particular division of functions. The methods described herein may be implemented in any appropriate manner using any appropriate number of computer systems and computer programs. References to a “computer system” are not restricted to a single computer or processor, but also include the use of multiple related computers to perform the function.

In accordance with one alternate embodiments, the generated data may be encoded as caption data and streamed using the WebVTT™ protocol with the video stream. Such techniques may be useful as not all systems are capable of extracting areas of received video frames for processing as required by the methods described herein. Where the WebVTT™ approach is utilized, applications at the receiving computer may be operable to extract the encoded data and utilize that data in a manner similar to that described herein.

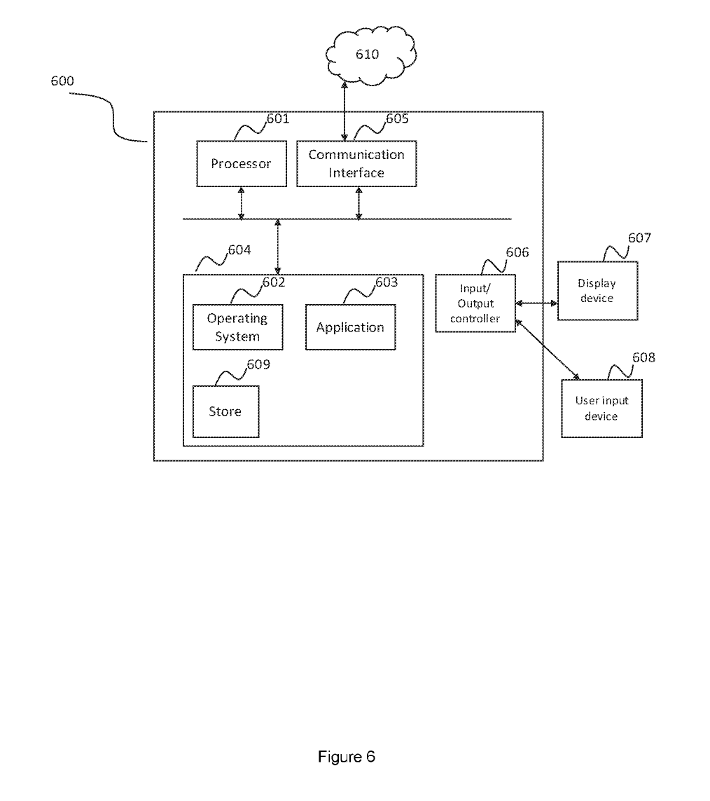

Turning now to FIG. 6, illustrated therein is a block diagram of an example computing system 600, in accordance with some embodiments. Computing system 600 may be implemented as any form of a computing and/or electronic device and may be operable to perform one or more parts of a process or steps described herein. For example, at least some of the steps of the method of FIG. 2 and/or the method of FIG. 5 may be implemented using computing-based devices having some or all of the features shown in FIG. 6.

In accordance with some embodiments, computing device 600, like other computer system described herein, may comprise one or more processors 601 which may be microprocessors, controllers or any other suitable type of processors for processing computer executable instructions to control the operation of the device in order to provide the functionality described hereinbefore. In some examples, for example where a system on a chip architecture is used, the processors 601 may include one or more fixed function blocks (also referred to as accelerators) which implement a part of the methods described hereinbefore in hardware (rather than software or firmware). Platform software comprising an operating system 602 or any other suitable platform software may be provided at the computing system 600 to enable application software 603 to be executed on the device.

The computer executable instructions may be provided using any computer-readable media that is accessible by computing device 600. Computer-readable media may include, for example, computer storage media such as memory 604 and communications media. Computer storage media, such as memory 604, may include volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 604) is shown within the computing-based device 600 it will be appreciated that the storage may be distributed or located remotely and accessed via a network 610 or other communication link (e.g. using communication interface 605). Memory 604 may also provide a store system 609 for storing data for use by the computing system, for example in the form of databases. Communication interface 605 may also provide an interface to systems of the mobile telecommunications network to provide communications and functions required to perform the methods described herein.

The computing-based device 600 may also comprise an input/output controller 606 arranged to output display information to a display device 607 which may be separate from or integral to the computing-based device 600. The display information may provide a graphical user interface. The input/output controller 606 may also be arranged to receive and process input from one or more devices, such as a user input device 608 (e.g. a mouse or a keyboard). In one embodiment the display device 607 may also act as the user input device. The input/output controller 606 may also output data to devices other than the display device, e.g. a locally connected printing device (not shown in FIG. 6).

The terms ‘computer’, ‘computing device’, ‘computing system’ and ‘computer system’ as used herein unless indicated otherwise refer to any device with processing capability such that it can execute instructions. Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Aspects of the methods described herein may be embodied in programming. Program aspects of the technology may be thought of as “products” or “articles of manufacture” typically in the form of executable code and/or associated data that is carried on or embodied in a type of machine readable medium and/or in a plurality of such media. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fibre optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Although the present embodiments have been described in terms of specific exemplary embodiments, it will be appreciated that various modifications, alterations and/or combinations of features disclosed herein will be apparent to those skilled in the art without departing from the spirit and scope of the invention(s) described herein (e.g., as set forth in the claims appended hereto).

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium or an article of manufacture, which may be non-transitory in nature). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “article of manufacture” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

What is claimed is:

1. A computer system for facilitating the synchronizing of video and related data being transmitted from a first computer system to a second computer system, the computer system comprising:
a memory storing a program comprising a data generation module, an encoding module and a video merge module, and
a processor that is operable with the at least one program to:
acquire video data representing a scene;
generate second data that at least partly relates to the scene represented by the video data,
encode the second data into a visual form to form a visual code;
form a composite image by merging the visual code with at least one frame of the video data; and
transmit, over an electronic network, the composite image to a second computer system.

2. The computer system of claim 1, wherein the processor is further operable with the program to:
transmit, to the second computer system and separate from the composite image, third data that is also related to the scene represented by the video data.

3. The computer system of claim 1, wherein the second data is encoded into a visual form by representing the second data as a binary number and representing each digit of the binary number as an area of pixels.

4. The computer system of claim 3, wherein one of a first color and a second color is selected for the pixels of the area corresponding to each digit dependent on the value of the digit.

5. The computer system of claim 4, wherein the area is an area of 8×8 pixels and the first color is white and the second color is black.

6. The computer system of claim 1, wherein the processor being operable with the program to form the composite image by merging comprises the processor being operable with the program to overwrite an area of the video frame with the visual code.

7. The computer system of claim 1, wherein the processor being operable with the program to form the composite image by merging comprises the processor being operable with the program to modify parameters of pixels of the video frame based on the visual code.

8. The computer system of claim 1, wherein the processor is further operable with the program to:
receive, at the second computer system, the composite image;
extract, at the second computer system, the visual code from the composite image;
decode, at the second computer system, the visual code to obtain the second data;
decode, at the second computer system, the composite image and displaying, on a display device of the second computer system, the scene represented by the video data of the composite image; and
displaying, on the display device, information derived from the second data.

9. The computer system of claim 8, wherein the processor is further operable with the program to:
receive, at the second computer system, the third data; and
display, on the display device, information derived from the third data.

10. The computer system of claim 8, wherein the processor is further operable with the program to:
process, at the second computer system, the video data such that the displayed scene does not include the visual code.

11. The computer system of claim 8, wherein the processor is further operable with the program to:
display, on the display device, the video data such that it includes the visual code.

12. A computer system for facilitating the synchronizing of video and related data being transmitted from a first computer system to a second computer system, the computer system comprising:
a memory storing a program comprising a video data processing module, and
a processor that is operable with the at least one program to:
receive a composite image that comprises video data merged with a visual code encoding second data related to a scene depicted in the video data, wherein the video data comprises at least one frame including the visual code;
extracting the visual code from the composite image;
decoding the visual code to obtain the second data encoded as the visual code;
decoding the video data;
displaying, on a display device of the second computer system, scenes represented by the video data; and
displaying, on the display device, information derived from the second data.

13. The computer system of claim 12, wherein the processor is further operable with the program to:
receive, at the second computer system and from the first computer system, third data that is received separately from the composite image and that is also related to the scene represented by the video data; and
display, on the display device, information derived from the third data.

14. The computer system of claim 12, wherein the processor is further operable with the program to:
process, at the second computer system, the video data such that the displayed scene does not include the visual code.

15. The computer system of claim 12, wherein the processor is further operable with the program to:
display, on the display device, the video data such that it includes the visual code.

16. The computer system of claim 12, wherein the second data is encoded into a visual form by representing the second data as a binary number and representing each digit of the binary number as an area of pixels.

17. The computer system of claim 16, wherein one of a first color and a second color is selected for the pixels of the area corresponding to each digit dependent on the value of the digit.

18. The computer system of claim 17, wherein the area is an area of 8×8 pixels and the first color is white and the second color is black.
